(19) United States
(12) Patent Application Publication
(10) Pub. No.: US 2016/0181797 A1
(43) Pub. Date: Jun. 23, 2016

(54) SOLAR ARRAY SIMULATION USING COMMON POWER SUPPLIES

(71) Applicant: The Boeing Company, Chicago, IL (US)

(72) Inventor: Thomas A. Pizoli, Redondo Beach, CA (US)

(21) Appl. No.: 14/573,618

(22) Filed: Dec. 17, 2014

(51) Int. Cl. H02J 1/00; G05B 17/02; H02S 99/00

(52) U.S. Cl. CPC H02J 1/00; H02S 99/00; G05B 17/02

(57) ABSTRACT

A system and method for simulating the output of a solar array is disclosed. The system includes a DC power supply having a DC voltage output that simulates the output of the solar array and a control input for receiving a signal controlling a magnitude of the DC voltage on the output. A current sensor provides an output current signal representing a magnitude of current output by the DC power supply. A controller has an input coupled to receive the output current signal from the current sensor and an output coupled to the control input of the DC power supply. The controller is configured to provide a signal on the output which varies the magnitude of the DC voltage output by the DC power supply based upon an initial value, a predetermined current-to-voltage characteristic stored in a memory and the output current signal received on the input.

### FIELD

This disclosure relates generally to electrical power supplies, and more specifically, to a solar array simulator constructed from a conventional power supply.

### BACKGROUND

Satellites and other spacecraft rely upon solar panels consisting of multiple solar cells for electrical power. Solar panels have unique current/voltage (IN) characteristics. A specialized power supply called a solar array simulator (SAS) is often used for testing and verifying a satellite's power system during manufacturing and assembly of a satellite or other spacecraft, since it is impractical to employ the actual solar panels in a manufacturing facility. A solar array simulator power supply is a specialized direct current (DC) power supply that acts to simulate the static current/voltage (IN) characteristics of silicon or gallium arsenide solar panels or arrays of solar panels. However, conventional solar array simulator power supplies have a limited load current capability, are costly and often have a form factor larger than desirable. In addition, such solar array simulator power supplies are limited to only operating according to solar panel IN characteristics.

Accordingly, there is a need for a solar array simulator power supply that overcomes the problems recited above.

### SUMMARY

In one aspect, a system for simulating the output of a solar array. The system includes a DC power supply having an output for providing a DC voltage which simulates the output of the solar array. The DC power supply also has a control input for receiving a signal controlling a magnitude of the DC voltage on the output. The system also includes a current sensor for providing an output current signal representing a magnitude of current output by the DC power supply. Finally, the system includes a controller having an input coupled to receive the output current signal from the current sensor and an output coupled to the control input of the DC power supply. The controller is configured to provide a signal on the output which varies the magnitude of the DC voltage output by the DC power supply based upon a predetermined current-to-voltage characteristic stored in a memory and the output current signal received on the input.

In a further embodiment, the controller may also include an interface for communicating with a host and may be further configured to receive, via the interface from the host, an updated predetermined current-to-voltage characteristic and to replace a previous predetermined current-to-voltage characteristic stored in the memory with the updated predetermined current-to-voltage characteristic. In a still further embodiment, the controller may be configured to provide the signal on the output at a fixed interval stored in a memory. Also, the controller may be further configured to receive, via the interface from the host, an updated fixed interval, and to replace a previous fixed interval stored in the memory with the updated fixed interval. In another further embodiment, the signal provided on the output is also based on a fixed initial value stored in a memory. Also, the controller may be further configured to receive, via the interface from the host, an updated fixed initial value, and to replace a previous fixed initial value stored in the memory with the updated fixed initial value.

The system may further include an analog to digital converter for converting the output current signal from the current sensor to a digital signal prior to receipt by the controller. In the alternative, the controller may be further configured to convert the output current signal from the current sensor to a digital signal after receipt from the current sensor. The system may also further include a digital to analog converter for converting the signal output by the controller to an analog signal prior to receipt by the power supply.

In another aspect, a dual mode power supply system for selectively simulating the output of a solar array or providing a fixed DC output voltage. The dual mode power supply system includes a DC power supply having an output for providing a DC voltage simulating the output of the solar array. The DC power supply also has a control input for receiving a signal controlling a magnitude of the DC voltage on the output. The dual mode power supply system also includes a current sensor for providing an output current signal representing a magnitude of current output by the DC power supply. Finally, the dual mode power supply system includes a controller having an input coupled to receive the output current signal from the current sensor and an output coupled to the control input of the DC power supply. The controller is configured to selectively operate in a first mode in which a signal is provided on the output which varies the magnitude of the DC voltage output by the DC power supply based upon a predetermined current-to-voltage characteristic and the output current signal received on the input and in a second mode in which a signal is provided on the output which sets the magnitude of the DC voltage output by the DC power supply to a predetermined fixed value.

In a third aspect, a method for simulating the output of a solar array. A DC power supply having an output for providing a DC voltage is provided. The DC voltage simulates the output of the solar array. The DC power supply also has a control input for receiving a signal controlling a magnitude of the DC voltage on the output. A magnitude of current output by the DC power supply is sensed. A signal is generated for varying the magnitude of the DC voltage output by the DC power supply based upon a predetermined current-to-voltage characteristic and the sensed magnitude of current output by the DC power supply. Finally, the generated signal is provided to the control input of the DC power supply. In a further embodiment, the providing step provides the generated signal to the control input of the DC power supply at a predetermined fixed interval.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a solar array simulator system according to the present disclosure;

FIG. 2 is a block diagram of a Field Programmable Gate Array for use in the solar array simulator system of the present disclosure; and

FIG. 3 is a block diagram of a scaling circuit for use in the solar array simulator system of the present disclosure.

### DETAILED DESCRIPTION

In the present disclosure, like reference numbers refer to like elements throughout the drawings, which illustrate various exemplary embodiments of the present disclosure.

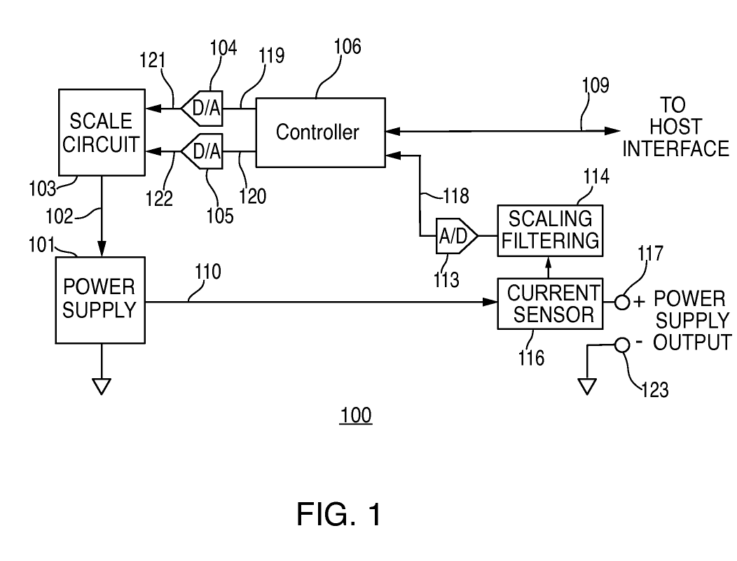

Referring now to FIG. 1, the solar array simulator system 100 of the present disclosure has DC voltage output (i.e., terminals 117, 123) and a communications interface 109 for communications with a host (not shown). System 100 includes a conventional power supply 101 having an output DC voltage line 110 and an analog input line 102 used to control the output voltage level provided on line 110. Suitable commercial power supplies for use in the system of the present disclosure include, for example, the SL Series Programmable DC Power Supplies from Magna-Power Electronics, Inc., the N8900 Series of Autoranging System DC Power Supplies from Agilent Technologies (now Keysight Technologies), and the Sorensen SG Series of Programmable Precision High Power DC Power Supplies from Ametek® Programmable Power. As one of ordinary skill in the art will readily recognize, other products from these same manufacturers and from other manufacturers which provide an analog input line for controlling the output voltage level may also be suitable for use in system of the present disclosure. The use of a conventional commercial power supply, instead of a specialized SAS power supply, is more cost-effect due to the lower cost and provides added flexibility for use of system 100 because system 100 may be used in an SAS mode (with the output voltage changing as the current changes according to a programmed IN curve) and in a non-SAS mode (with the output voltage fixed and independent of the output current). As one of ordinary skill in the art will readily recognize, although power supply 101 will include internal conditioning and protection circuitry, in some embodiments it may be desirable to provide additional conditioning and/or protection circuits on the output line 110 from power supply 101.

A current sensor 116 is coupled between the output line 110 from power supply 101 and the positive power supply output terminal 117. Current sensor 116 is preferably a Hall effect sensor, but, as one of ordinary skill in the art will readily recognize, other types of current sensors may also be used. The sense signal from the current sensor 116 is provided to a scaling/filtering circuit 114 and then, after scaling/filtering, to an analog to digital (A/D) converter 113. The output of A/D converter 113 is provided as an input to a controller 106 (discussed below) via line 118. The output of A/D converter 113 is a signal representing the output current sensed by output current sensor 116 (i.e., this signal is “an output current signal”). This input on line 118 provides controller 106 with a digital input signal representing the actual DC output current being provided by system 100 on output terminal 117. In an alternative embodiment, controller 106 may include an integral A/D converter and the signal from scaling/filtering circuit 114 may be provided directly to an analog signal input on controller 106. Still further, in some embodiments scaling/filtering circuits 114 may be omitted.

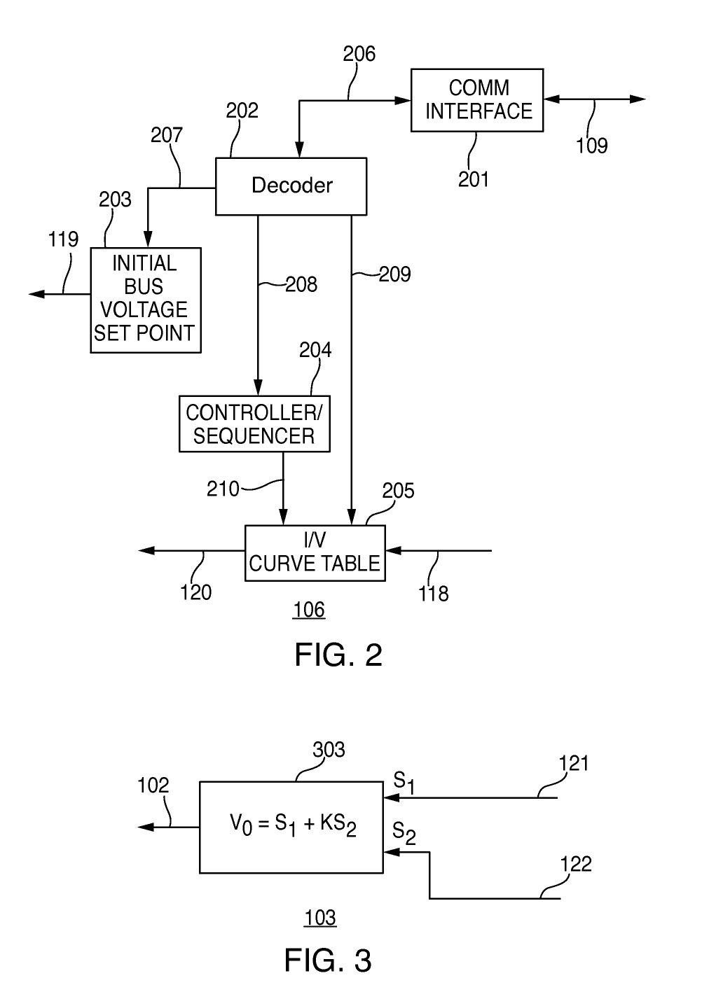

Controller 106 communicates with a host computer via a host communications interface 109. Host communications interface 109 may be any conventional communications interface including, but not limited to, Ethernet, USB, RS-485 or CAN bus. As one of ordinary skill in the art will readily recognize, the circuitry for communicating via the selected communications interface may be included within controller 106 or may be external to controller 106. As discussed below with respect to FIG. 2, in one embodiment controller 106 is a Field-Programmable Gate Array integrated circuit, but in other embodiments may be a programmed microcontroller, an application specific integrated circuit or a custom integrated circuit. The communications interface 109 allows external configuration of the operation of system 100, including downloading predetermined I/V curve information tables, initial voltage settings, sequencer settings, and operation mode (i.e., SAS or non-SAS). The ability to download different I/V curve information tables allows system 100 to simulate the operation of a wide variety of solar arrays.

Controller 106 includes two output terminals coupled, respectively, to signal lines 119, 120, as explained in detail with respect to FIG. 2. Controller 106 outputs a digital signal on signal line 119 which is a digital representation of the initial power supply output voltage setting and a digital signal on signal line 120 which is a digital representation of the adjustment necessary to the initial power supply voltage setting that is determined based on the DC output current level measured via current sensor 116 (which is determined based on the presently programmed I/V curve). As one of ordinary skill in the art will readily recognize, signal lines 119, 120 may each transmit serial signals (and thus each may consist of a single conductor) or may each transmit parallel signals (and thus each may consist of multiple conductors). Signal line 119 is coupled to an input of digital-to-analog (D/A) converter 104, and signal line 120 is coupled to an input of digital-to-analog (D/A) converter 105. The output of D/A converter 104 is provided via line 121 as a first input to scale circuit 103 and the output of D/A converter 105 is provided via line 122 as a second input to scale circuit 103. Scale circuit 103 provides an output consisting of a scaled sum of the two input signals, as described in more detail with respect to FIG. 3. As discussed in the Background, solar panels provide output power having a particular current to voltage characteristic. Controller 106 sets an initial output voltage level on line 119 and then, based on the predetermined I/V characteristic curve stored in memory within controller 106, provides an adjustment signal on line 120 that is determined from the measured output current level (as input on line 118). As one of ordinary skill in the art will readily recognize, in an alternative embodiment, controller 106 may be programmed to perform the scaling done by scale circuit 103 internally, and provide a single digital output that is then converted to an analog signal that is provided directly to power supply 101. This alternative embodiment requires only a single D/A converter. Still further, controller 106 may alternatively include an integral D/A converter and controller 106 may output a single analog signal that is coupled directly to power supply 101 that is based on the sum of the initial output voltage level and the adjustment signal.

In one embodiment, controller 106 is a Field-Programmable Gate Array integrated circuit (FPGA). Referring now to FIG. 2, FPGA 106 includes a communications interface 201 coupled to host communications interface 109. Communications interface 201 receives messages from the host computer (not shown) and forwards such messages via line 206 to decoder 202. Decoder 202 is coupled to the initial bus voltage set point block 203 via line 207, to controller/sequencer 204 via line 208 and to IN curve table 205 via line 209. Initial bus voltage set point block 203 is a memory location that controls the digital signal output on line 119. Controller/sequencer 204, in turn, is coupled to IN curve table 205. Controller/sequencer 204 is used to control the timing for changes made to the adjustment signal on line 120. For example, controller/sequencer 204 may be a programmable clock circuit which is set to enable, via line 210, changes based on the programmed timing of the clock circuit, e.g., every 10 μsec or every 100 μsec. As one of ordinary skill in the art will readily recognize, the adjustment signal on line 120 may be gated in other ways as well, and in some cases it may be possible to omit controller/sequencer 204 and simply let the output on line 120 change dynamically in response to changes in the output current signal received on line 118. The use of a programmable clock, for example, provides added flexibility because the system 100 can be converted to a non-SAS mode simply by disabling the clock (in which case no adjustment signal will be provided on line 120) and setting the output buffer in IN curve table 205 to zero. The ability to provide a dual mode power supply having both an SAS mode and a non-SAS mode provides added flexibility over conventional off-the-shelf commercial SAS power supplies. The IN curve table 205 is a memory which stores a look-up table that is used, based on the digital input provided on line 118 (i.e., a digital signal representing the current presently being output on terminal 117), to determine the adjustment signal to be output on line 120. As discussed above, the signal on line 120 changes under the control of controller/sequencer 204 (preferably based on the programmed clock timing) to provide an adjustment signal on line 120 that is based on a value stored in IN curve table 205 that corresponds to the output current signal on line 118. Decoder 202 receives each message from the host and, based on addressing included therein, forwards such message to initial bus set point block 203 (to set the initial voltage level), controller/sequencer 204 (to set the mode and the timing of signal changes on line 120) or to I/V curve table 205 (to store a new I/V curve table). FPGA 106 is initially programmed by the host computer to set the initial bus voltage set point, the mode and the signal change timing and to store the IN curve table. In operation simulating a particular solar array, FPGA 106 outputs a static digital signal on line 119 representing the initial bus voltage set point and a dynamic digital signal on line 120 that chosen from the IN curve table based on the input current level on line 118.

In an alternative embodiment, the initial bus voltage set point block 203 may be omitted and the I/V curve table stored in memory in block 205 can be biased to include the initial bus voltage set point. In this alternative embodiment, the scale circuit 103 may also be omitted and the signal 122 in FIG. 1 may be provide directly to power supply 101 on line 102. The use of a Field-Programmable Gate Array 106, with minimal additional circuitry, is much more cost-effective than purchasing an off-the-shelf solar array simulator and provides additional flexibility in selecting loading current requirements because of the limited range available for commercial off-the-shelf solar array simulators.

In other embodiments, as discussed above, controller 106 may comprise a programmed microcontroller or a custom integrated circuit. In still further embodiments, controller 106 may include integral A/D and D/A converters, instead of the discrete separate A/D converter 113 and D/A converters 104, 105 shown in FIG. 1

Referring now to FIG. 3, signal 51 represents the initial setting for power supply 101 (i.e., the initial bus voltage set point) while signal S2 (the signal on line 122) represents the adjustment required to the initial bus voltage set point based on the present current output. Sum circuit 303 provides an output Vₒ that is equal to signal 51 plus k times signal S2 (where k is a scaling factor that can be positive, negative or even “1” in some cases, depending on the relative values in the I/V curve table). In some alternative embodiments, as discussed above, the processing performed by scale circuit 103 may be performed in the digital domain (e.g., when a microcontroller is used for controller 106) and in this case only a single D/A controller may be required. In another alternative embodiment, power supply 101 may include a digital input terminal for setting the output voltage, in addition to analog input line 102. In this alternative embodiment, the processing performed by scale circuit 103 may be formed in the digital domain in controller 106, and controller 106 may output a digital signal directly to power supply 101, bypassing the need for any D/A converters at all.

System 100 provides a flexible alternative to commercial off the shelf solar array simulators. In operation, system 100 is configurable to provide any desired solar array I/V curve and also may be configured to operate in a fixed output voltage mode, with the output voltage fixed and independent of the current draw. Furthermore, system 100 allows selection of a commercial off the shelf power supply appropriate for the loading requirements for the particular system under test, and the conversion of such system to a solar array simulator at a much lower cost than available commercial off the shelf solar array simulators.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A system for simulating the output of a solar array, comprising:
a DC power supply having a DC voltage output for providing a DC voltage, the DC voltage simulating the output of the solar array, the DC power supply also having a control input for receiving a signal controlling a magnitude of the DC voltage on the DC voltage output;
a current sensor for providing an output current signal representing a magnitude of current output by the DC power supply; and
a controller having an input coupled to receive the output current signal from the current sensor and an output coupled to the control input of the DC power supply, the controller configured to provide a signal on the output of the controller which varies the magnitude of the DC voltage output by the DC power supply based upon a predetermined current-to-voltage characteristic stored in a memory and the output current signal received on the input.

2. The system of claim 1, wherein the controller further comprises an interface for communicating with a host; wherein the controller is further configured to receive, via the interface from the host, an updated predetermined current-to-voltage characteristic, and to replace a previous predetermined current-to-voltage characteristic stored in the memory with the updated predetermined current-to-voltage characteristic.

3. The system of claim 2, wherein the controller is configured to provide the signal on the output of the controller at a fixed interval stored in the memory.

4. The system of claim 3, wherein the controller is further configured to receive, via the interface from the host, an updated fixed interval, and to replace a previous fixed interval stored in the memory with the updated fixed interval.

5. The system of claim 2, wherein the signal provided on the output of the controller is also based on a fixed initial value stored in the memory.

6. The system of claim 5, wherein the controller is further configured to receive, via the interface from the host, an updated fixed initial value, and to replace a previous fixed initial value stored in the memory with the updated fixed initial value.

7. The system of claim 1, further comprising an analog to digital converter for converting the output current signal from the current sensor to a digital signal prior to receipt by the controller.

8. The system of claim 1, wherein the controller is further configured to convert the output current signal from the current sensor to a digital signal after receipt from the current sensor.

9. The system of claim 1, further comprising a digital to analog converter for converting the signal output by the controller to an analog signal prior to receipt by the power supply.

10. A dual mode power supply system for selectively simulating the output of a solar array or providing a fixed DC output voltage, comprising:
a DC power supply having a DC voltage output for providing a DC voltage, the DC voltage simulating the output of the solar array, the DC power supply also having a control input for receiving a signal controlling a magnitude of the DC voltage on the DC voltage output;
a current sensor for providing an output current signal representing a magnitude of current output by the DC power supply; and
a controller having an input coupled to receive the output current signal from the current sensor and an output coupled to the control input of the DC power supply, the controller configured to selectively operate in a first mode in which a signal is provided on the output of the controller which varies the magnitude of the DC voltage output by the DC power supply based upon a predetermined current-to-voltage characteristic and the output current signal received on the input and in a second mode in which a signal is provided on the output of the controller which sets the magnitude of the DC voltage output by the DC power supply to a predetermined fixed value.

11. The system of claim 10, wherein the controller further comprises an interface for communicating with a host; wherein the controller is further configured to receive, via the interface from the host, an updated predetermined current-to-voltage characteristic, and to replace a previous predetermined current-to-voltage characteristic stored in a memory with the updated predetermined current-to-voltage characteristic.

12. The system of claim 11, wherein the controller is configured to provide the signal on the output of the controller at a fixed interval stored in the memory.

13. The system of claim 12, wherein the controller is further configured to receive, via the interface from the host, an updated fixed interval, and to replace a previous fixed interval stored in the memory with the updated fixed interval.

14. The system of claim 11, wherein the signal provided on the output of the controller is also based on a fixed initial value stored in a memory.

15. The system of claim 14, wherein the controller is further configured to receive, via the interface from the host, an updated fixed initial value, and to replace a previous fixed initial value stored in the memory with the updated fixed initial value.

16. The system of claim 10, further comprising an analog to digital converter for converting the output current signal from the current sensor to a digital signal prior to receipt by the controller.

17. The system of claim 10, wherein the controller is further configured to convert the output current signal from the current sensor to a digital signal after receipt from the current sensor.

18. The system of claim 10, further comprising a digital to analog converter for converting the signal output by the controller to an analog signal prior to receipt by the power supply.

19. A method for simulating the output of a solar array, comprising:
providing a DC power supply having a DC voltage output for providing a DC voltage, the DC voltage simulating the output of the solar array, the DC power supply also having a control input for receiving a signal controlling a magnitude of the DC voltage on the DC voltage output;
sensing a magnitude of current output by the DC power supply;
generating a signal for varying the magnitude of the DC voltage output by the DC power supply based upon a predetermined current-to-voltage characteristic and the sensed magnitude of current output by the DC power supply; and
providing the generated signal to the control input of the DC power supply.

20. The method of claim 19, wherein the providing step provides the generated signal to the control input of the DC power supply at a predetermined fixed interval.
